(19) United States
(12) Patent Application Publication
(10) Pub. No.: US 2012/0060962 A1
(43) Pub. Date: Mar. 15, 2012

(54) TUBE OR MOLDED TUBE ELEMENT

(76) Inventors: Volker Liebel, Erlangen (DE); Ralf Helmold, Bielefeld (DE)

(21) Appl. No.: 13/318,642

(22) PCT Filed: Mar. 29, 2010
(86) PCT No.: PCT/EP2010/001973

§ 371 Date: Nov. 3, 2011

(30) Foreign Application Priority Data
May 7, 2009 (DE) 20 2009 006 553.7

(51) Int. Cl. F16L 9/00

(52) U.S. Cl. 138/177

(57) ABSTRACT

The invention relates to a tube or molded tube element for receiving, storing or guiding air, containing at least a percentage of a chlorine-containing polymer material, and further containing at least one biocidally active component. The invention is characterized in that the polymer material is stabilized by a composition which contains at least one calcium compound.

The present invention relates to a tube or a molded tube element, in particular for receiving, storing or guiding air, containing at least a percentage of a chlorine-containing polymer material, and further containing at least one component that is biocidally active.

Tubes or molded tube elements of this type are used, e.g., in controlled residential ventilation for modern house concepts such as passive-energy/ultra-low energy houses or low-energy houses. The supply of fresh air is hereby carried out via a buried pipe system.

From the prior art in this context a heat exchanger tube is known according to DE 20301249 U1, which is suitable for being laid in the earth and has a tube body, which is composed of a base polymer material with embedded fillers of a material with material properties that area modified with respect to the base polymer material.

The use of polyvinyl chloride (PV) for the production of tubes or molded tube elements of this type has hitherto been limited by the fact that there are interactions between the biocidally active component and the stabilizers added to the PVC, which in the long term lead to a degradation of PVC and thus damage the tubes or molded tube elements in particular with respect to their mechanical properties.

The object of the invention is therefore to provide a tube or a molded tube element which counteracts a deposition of microorganisms and at the same time is based on a stabilized, chlorine-containing polymer material and furthermore can be produced easily and cost-effectively.

The object is attained according to the invention in that a tube or a molded tube element is provided, which is used for receiving, storing or guiding air, which contains at least proportionally a chlorine-containing polymer material, which furthermore contains at least one component that is biocidally active and which is characterized in that the polymer material is stabilized with a composition that contains at least one calcium compound.

A stearate, a laurate or an acetylacetonate can be selected as a calcium compound that stabilizes the chlorine-containing polymer material.

In a further preferred embodiment of the invention, the chlorine-containing polymer material can in addition contain a zinc compound for stabilization, wherein the zinc compound is selected from the group of stearates, laurates and acetylacetonates.

Within the scope of the present invention, it can furthermore be provided as an advantage that at least one co-stabilizer is present, which is selected from the group of the isocyanurates, carbonates, polyol compounds, uracils and the sterically hindered amines.

The selection of the above-mentioned stabilizers or co-stabilizers leads to a stabilization of the chlorine-containing polymer material, which is particularly advantageous, wherein said material stabilized in this manner exhibits hardly any degradation phenomena and thus is durable and maintains its mechanical properties.

The tube or molded tube element according to the invention contains a biocidally active component in the chlorine-containing polymer material, which biocidally active component is selected from the group of bactericides, fungicides and algicides.

Hereby, the growth of a so-called biofilm on the inner surface of the tubes or molded tube elements can be limited or prevented in a particularly effective manner.

The biocidally active component is selected from the group that is composed of silver (Ag), zinc (Zn), copper (Cu), tin (Sn), iodine (I), tellurium (Te), germanium (Ge), chromium (Cr), the ions thereof and compounds and mixtures thereof.

Organo-silver compounds are particularly preferred, in addition also inorganosilver compounds, zinc-organic compounds and zinc-inorganic compounds.

Alternatively, it can be provided that the biocidally active component is triclosan or a quaternary ammonium compound.

In particular, it can also be provided that the concentration of the biocidally active component is greatest in the region of the inner surface and decreases steadily in the direction of the outer surface.

Hereby, a low quantity of biocidally active component is required for the production of the tube.

It is thus possible within the scope of the present invention to considerably reduce germs such as bacteria, fungi, yeasts and algae on the inner surface of the tube or of the molded tube element and to achieve an improvement of the hygiene of the fluid flowing through the hollow body. As a result, undesirable odors are not emitted to the fluid flowing past.

Polyvinyl chloride (PVC), polyvinylidene chloride (PVDC) or chlorinated polyethylene (PE-C) are suitable as a chlorine-containing polymer material for producing the tube or the tube molded element according to the present invention.

The above-mentioned polymer materials have favorable mechanical and physical or chemical properties, especially as they are relatively inexpensive and can be easily processed.

The selection of the above-mentioned polymer materials, the above-mentioned biocidally active component and the composition stabilizing the polymer material is selected according to the invention such that no reactions occur between biocidally active components and stabilizers which result in a negative effect on the stabilization of the polymer material.

This ensures a long-term effectiveness of the biocidally active component as well as a stabilization of the chlorine-containing polymer material lasting over a very long period. Thus a high-quality tube or molded tube element results, which in particular is durable, without causing a perceptible reduction in the biocidal effectiveness or the mechanical properties over time. A product of this type is very high quality and meets or exceeds customer requirements.

Within the scope of the invention, it can be further provided that the tube or the molded tube element has a wall, which is constructed so as to be multi-layered.

Hereby it is advantageous if the chlorine-containing polymer material is contained in the inner layer facing the bore of the tube.

In this manner the formation of a biofilm on the inner surface of the hollow body is reduced or prevented.

Furthermore, it can be advantageously provided that the outer layer of the tube or molded tube element facing away from the bore of the tube, contains a chlorine-containing polymer material.

This can be the same as or different from the polymer material of the inner layer. In this manner it is possible to produce tubes, for example, in a co-extrusion process, wherein only the inner layer is equipped in a biocidally active manner.

Here, the outer layer has the function of forming the actual stable tube body; for this purpose, the thickness of the inner layer may be selected to be much smaller than the thickness of the outer layer.

The ratio of the thicknesses of the two layers is 1:20, preferably 1:12 and particularly preferably about 1:8.

In a particularly preferred embodiment of the invention, the outer layer may be provided to contain a chlorine-containing polymer material, which has a tin compound. The tin compound can be an organic tin carboxylate or an organic tin mercaptide. The inner layer of the tube or of the molded tube element thereby contains a chlorine-containing polymer material that has a calcium compound and a zinc compound.

A tube or molded tube element is hereby created, which is formulated to be highly stable and which is biocidally active as well as stable over a long period with respect to degradation reactions.

In a preferred further refinement of the invention, the tube or the molded tube element can contain an additive in the chlorine-containing polymer material, which additive increases the thermal conductivity of the polymer material.

An additive of this type which increases the thermal conductivity of the polymer material can be a material that is inert in the polymer matrix and that has a high density. Suitable additives are: talcum, glass, mica, wollastonite, silicon dioxide and silicates, silicic acid, quartz, titanium dioxide, shale, kaline, barite, clays, metal oxides or other suitable, in particular inorganic fillers.

It is thus possible to create a tube or molded tube element which renders possible a particularly favorable heat transfer from the earth to the fluid or from the fluid to the earth.

Tubes or molded tube elements of this type are particularly effective in terms of heat exchange between the earth and fluid.

Further additives can also be contained in the polymer material of the tube or of the molded tube element. These are, for example: fillers, colorants, sunscreen stabilizers, slip agents, antistatic agents, and others.

Tubes according to the present invention can be produced particularly efficiently in an extrusion process, or as those of multi-layered construction, in a co-extrusion process.

Other manufacturing methods are also conceivable. Pressing, casting, rotational casting, winding and other processes are suitable.

Molded tube elements, such as, for example, fittings, arches, tappings and junctions can be produced in the injection molding process.

However, other manufacturing methods are also suitable, these include, in addition to welding and adhesion processes, bending, casting, pressing, rotational casting and other methods, in particular also methods combined with those listed above.

These other manufacturing processes, in addition to the injection molding process, offer the advantage that the inexpensive co-extruded tube can be used as a starting material for the production of the molded parts.

Another advantage is that the molded tube elements also have the biocidally active property of the inner layer, which can be implemented only at great expenditure in the injection molding process.

The tube or the molded tube element of the present invention can be used as a conduit or as a heat exchanger tube which is buried in the earth.

Particularly advantageously, a tube or a molded tube element of this type can be used in a tube system, which, in particular, is used to extract heat from the earth or for the input of heat into the earth.

In addition to the advantageous embodiments of the tube or the molded tube element described above, all possible combinations thereof are also conceivable.

The features and advantages of the invention are presented in more detail in the description below, wherein reference is made to the attached drawings, which are not to scale, which show the following:

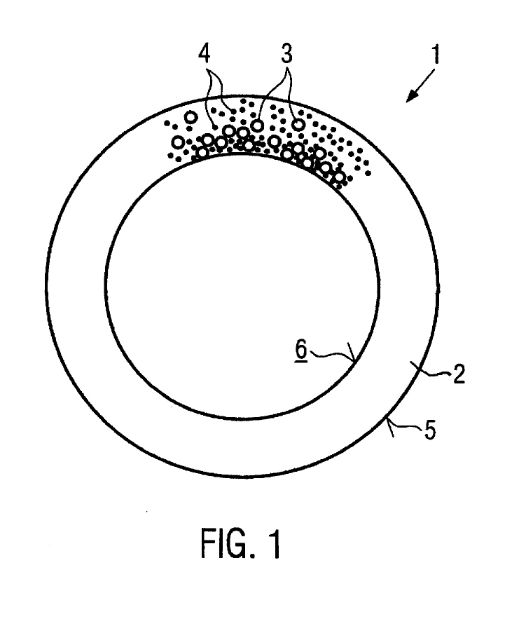

FIG. 1: Sectional view of a single-layer tube according to the invention,

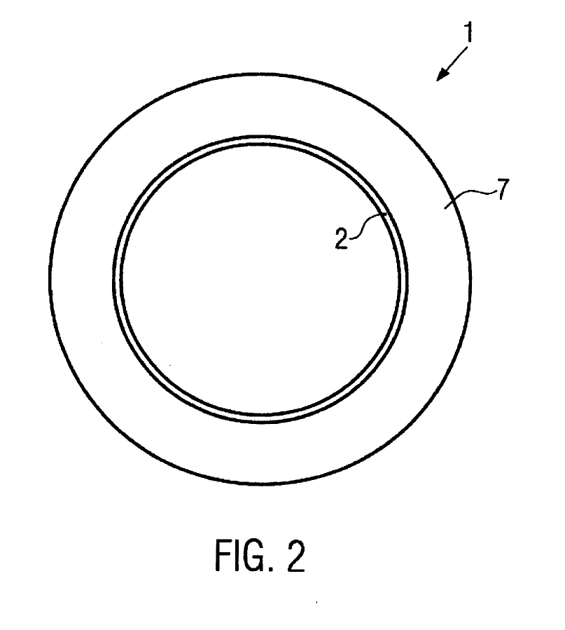

FIG. 2: Sectional view of a two-layered tube according to the invention.

The illustration according to FIG. 1, which is true to scale, shows a section through a single-layer tube 1 according to the invention, wherein the tube 1 has a layer 2 with an outer surface 5 and an inner surface 6. The layer 2 contains polyvinyl chloride as a matrix material, in which the biocidally active component 3 in the form of a organo-silver compound and the stabilizing composition 4 are embedded.

The concentration of the biocidally active component 3 is greatest in the region of the inner surface 6 and steadily decreases in the direction of the outer surface 5.

The illustration according to FIG. 2, which is not true to scale, shows a section through a two-layered tube 1 according to the invention produced in a co-extrusion process with an inner layer 2 and an outer layer 7 connecting on the outside. The inner layer 2 hereby corresponds to the layer shown in FIG. 1 and has the same structure. The outer layer 7 is composed of a polyvinyl chloride, which is different from the polyvinyl chloride of the layer 2.

The ratio of the thicknesses of the two layers 2 and 7 is about 1:8.

The inner layer 2 of the tube 1 contains a polyvinyl chloride which has a calcium compound and a zinc compound.

The outer layer 7 of the tube 1 contains a polyvinyl chloride, which is different from the polyvinyl chloride of the inner layer 2; this has a tin compound.

1. A tube or a molded tube element for receiving, storing or guiding air, which contains at least a percentage of a chlorine-containing polymer material, which contains furthermore at least one biocidally active component, wherein the polymer material is stabilized with a composition that contains at least one calcium compound.

2. The tube or the molded tube element according to claim 1, wherein the calcium compound is selected from a group of compounds consisting of stearates, laurates and acetylacetonates.

3. The tube or the molded tube element according to claim 1, wherein it contains a zinc compound.

4. The tube or the molded tube element according to claim 3, wherein the zinc compound is selected from a group of compounds consisting of stearates, laurates and acetylacetonates.

5. The tube or the molded tube element according to claim 1 wherein it contains at least one co-stabilizer, selected from a group of co-stabilizers consisting of the isocyanurates, carbonates, polyol compounds, uracils and the sterically hindered amines.

6. The tube or the molded tube element according to claim 1 wherein the biocidally active component is selected from a group of components consisting of bactericides, fungicides and algicides.

7. The tube or the molded tube element according to claim 6, wherein the biocidally active component is selected from a group of components consisting of silver (Ag), zinc (Zn), copper (Cu), tin (Sn), iodine (I), tellurium (Te), germanium (Ge), chromium (Cr), the ions thereof and compounds and mixtures thereof, in particular organo-silver compounds, inorgano-silver compounds, zinc-organic compounds and zinc-inorganic compounds.

8. The tube or the molded tube element according to claim 6, wherein the biocidally active component is triclosan or a quaternary ammonium compound.

9. The tube or the molded tube element according to claim 1 wherein the chlorine-containing polymer material is selected from a group of chlorine-containing polymer materials consisting of polyvinyl chloride (PVC), polyvinylidene chloride (PVDC), chlorinated polyethylene (PE-C).

10. The tube or the molded tube element according to claim 1 wherein the tube or tube element comprises a wall constructed in a multi-layered manner, wherein the chlorine-containing polymer material is contained in the inner layer that faces towards the bore of the tube.

11. The tube or the molded tube element according to claim 1 wherein the tube or tube element comprises an outer layer that faces away from the bore of the tube and contains a chlorine-containing polymer material, which is the same as or different from the polymer material of the inner layer.

12. The tube or the molded tube element according to claim 1 wherein the tube or tube element comprises an outer layer which contains a chlorine-containing polymer material that has a tin compound, and the inner layer contains a chlorine-containing polymer material that has a calcium compound and a zinc compound.

13. The tube or the molded tube element according to claim 1 wherein the chlorine-containing polymer material contains an additive which increases the thermal conductivity of the polymer material.

14. The tube or the molded tube element according to claim 1, used as a conduit or a heat exchanger tube which is laid in the earth.

15. A tube system, in particular for extracting heat from the earth or for inputting heat into the earth, with at least one tube or molded tube element according to claim 1.

16. The tube or the molded tube element according to claim 2, wherein that it contains a zinc compound.

17. The tube or the molded tube element according to claim 2 wherein it contains at least one co-stabilizer selected from a group of co-stabilizers consisting of isocyanurates, carbonates, polyol compounds, uracils and the sterically hindered amines.

18. The tube or the molded tube element according to claim 3 wherein it contains at least one co-stabilizer selected from a group of co-stabilizers consisting of isocyanurates, carbonates, polyol compounds, uracils and the sterically hindered amines.

19. The tube or the molded tube element according to claim 4 wherein it contains at least one co-stabilizer selected from a group of co-stabilizers consisting of isocyanurates, carbonates, polyol compounds, uracils and the sterically hindered amines.

20. The tube or the molded tube element according to claim 2 wherein the biocidally active component is selected from a group of biocidally active compounds consisting of bactericides, fungicides and algicides.
